(19) United States
(12) Patent Application Publication
(10) Pub. No.: US 2021/0283498 A1
(43) Pub. Date: Sep. 16, 2021

(54) DATA PROCESSING METHOD AND APPARATUS, AND DEVICE, SERVER, SYSTEM AND STORAGE MEDIUM

(71) Applicant: SHANGHAI SENSETIME INTELLIGENT TECHNOLOGY CO., LTD., Shanghai (CN)

(72) Inventors: Junwei ZHANG, Shanghai (CN); Cheng LI, Shanghai (CN); Yiqing LIANG, Shanghai (CN)

(21) Appl. No.: 17/336,914

(22) Filed: Jun. 2, 2021

Related U.S. Application Data
(63) Continuation of application No. PCT/CN2020/091911, filed on May 22, 2020.

(30) Foreign Application Priority Data
Jul. 26, 2019 (CN) 201910684555.5

(51) Int. Cl. A63F 13/35; A63F 13/60; G06F 9/54

(52) U.S. Cl. CPC A63F 13/35; G06F 9/54; A63F 13/60

(57) ABSTRACT

A data processing method, a data processing apparatus, a webpage processing device, a server, a system, and a storage medium are provided. The method comprises: a Python back end obtains a data processing instruction (S301); the Python back end obtains a data processing result according to the data processing instruction (S302); the Python back end generates a processing file according to the data processing result, so that a Unity front end reads the processing file using a preset interface, and displays a page according to the processing file (S303).

### CROSS-REFERENCE TO RELATED APPLICATIONS

This is a continuation application of International Application No. PCT/CN2020/091911, filed May 22, 2020, which claims priority to Chinese Patent Application No. 201910684555.5, filed on Jul. 26, 2019. The entire contents of International Application No. PCT/CN2020/091911 and Chinese Patent Application No. 201910684555.5 are hereby incorporated by reference in their entireties.

### BACKGROUND

Unity is one of the most mainstream frameworks in game development, which is not only applied to game development, but also applied to make colorful frontend interfaces such as three dimensions (3D)/two dimensions (2D), and released on a browser through the World Wide Web Graphics Library (WebGL).

However, Python, as a dynamic and object-oriented scripting language, is used for a backend of web page development (such as web game development). However, on the premise that the Python is used for the backend, during manipulating a frontend interface of the Unity, since a scripting language accepted by the Unity is C sharp, generally, if a user needs to manipulate a game using the Python, it is necessary to use a plug-in IronPython in a Unity frontend and write a corresponding interface.

The IronPython requires a dynamic link, that is, the IronPython can only be used in a text of an editor of the Unity. If the Unity is released to the WebGL (indicating that the game becomes a static environment), the IronPython will fail, and manipulations of the Python will fail, resulting in that the web page cannot operate normally.

### SUMMARY

Embodiments of the present disclosure relate to the technical field of data processing, and provide a method and apparatus for data processing, a device, a server, a system and a storage medium.

The embodiments of the present disclosure provide a method for data processing, which includes the following operations. A Python backend acquires a data processing instruction. The Python backend obtains a data processing result according to the data processing instruction. The Python backend generates a processing file according to the data processing result, to enable a Unity frontend to read the processing file using a preset interface and perform page display according to the processing file. In this way, it is beneficial for the Unity frontend to read the processing file of the Python backend and respond to the data processing instruction acquired by the Python backend in time, thereby implementing normal interaction between the Python backend and the Unity frontend, and then implementing normal operation of a web page including the Python backend and the Unity frontend.

The embodiments of the present disclosure provide a method for data processing, which includes the following operations. A Unity frontend reads a processing file using a preset interface. The processing file is a result file generated by a Python backend according to a data processing result, and the data processing result is obtained by the Python backend according to an acquired data processing instruction. The Unity frontend performs page display according to the processing file. In this way, it is beneficial for the Unity frontend to read the processing file of the Python backend and read the processing file from the Python backend in time, thereby achieving normal interaction between the Python backend and the Unity frontend and then achieving normal operation of a web page including the Python backend and the Unity frontend.

The embodiments of the present disclosure provide a method for data processing, which is applied to a server and includes the following operations. A data processing instruction from a Python backend is received. A data processing result is obtained according to the data processing instruction. The data processing result is sent to the Python backend, to enable the Python backend to generate a processing file according to the data processing result, and enable a Unity frontend to read the processing file using a preset interface and perform page display according to the processing file. In this way, through processing the data processing instruction by the server to obtain the data processing result, flexibility of processing the data processing instruction is increased, more processing tasks for the Python backend are shared and the processing efficiency is improved. In addition, it is beneficial for the Unity frontend to read the processing file of the Python backend and respond to the data processing instruction acquired by the Python backend in time, thereby implementing normal interaction between the Python backend and the Unity frontend by means of server, and then implementing normal operation of a web page including the Python backend and the Unity frontend.

The embodiments of the present disclosure provide an apparatus for data processing, which includes an acquisition module, a first determining module and a first generating module. The acquiring module is configured to acquire a data processing instruction. The first determining module is configured to obtain a data processing result according to the data processing instruction. The first generating module is configured to generate a processing file according to the data processing result, to enable a Unity frontend to read the processing file using a preset interface and perform page display according to the processing file.

The embodiments of the present disclosure also provide an apparatus for data processing, which includes a reading module and a display module. The reading module is configured to read a processing file using a preset interface. The processing file is a result file generated by a Python backend according to a data processing result, and the data processing result is obtained by the Python backend according to an acquired data processing instruction. The display module is configured to perform page display according to the processing file.

The embodiments of the present disclosure also provide an apparatus for data processing, which includes a receiving module, a second determining module and a sending module. The receiving module is configured to receive a data processing instruction from a Python backend. The second determining module is configured to obtain a data processing result according to the data processing instruction. The sending module is configured to send the data processing result to the Python backend, to enable the Python backend to generate a processing file according to the data processing result, and enable a Unity frontend to read the processing file using a preset interface and perform page display according to the processing file.

The embodiments of the present disclosure also provide a web page processing device, which includes a processor, a memory and a communication bus. The communication bus is configured to implement connection communication between the processor and the memory. The processor is configured to execute a data processing program stored in the memory to implement at least one of the method for data processing executed by the Python backend in the above one or more embodiments or the method for data processing executed by the Unity frontend in the above one or more embodiments.

The embodiments of the present disclosure provide a server, which includes a processor, a memory and a communication bus. The communication bus is configured to implement connection communication between the processor and the memory. The processor is configured to execute a data processing program stored in the memory to implement the method for data processing executed by the server in the above one or more embodiments.

The embodiments of the present disclosure provide a data processing system. The system includes the web page processing device in one or more of the embodiments mentioned above and the server in one or more embodiments mentioned above.

The embodiments of the present disclosure provide a computer readable storage medium having stored one or more programs. The one or more programs are executable by one or more processors to implement the method for data processing executed by the Python backend in the above one or more embodiments, the method for data processing executed by the Unity frontend in the above one or more embodiments, or the method for data processing executed by the server in the above one or more embodiments.

The embodiments of the present disclosure provide a computer program, which includes computer readable codes. When the computer readable codes are run in an electronic device, a processor in the electronic device performs the computer readable codes to implement the method for data processing performed by the Python backend in the above one or more embodiments, or the method for data processing performed by the Unity frontend in the above one or more embodiments, or the method for data processing performed by the server in the one or more embodiments.

The embodiments of the present disclosure provide a method and apparatus for data processing, a device, a server, a system, and a storage medium. The method includes the following operations. First, a Python backend acquires a data processing instruction, then the Python backend obtains a data processing result according to the data processing instruction, and finally, the Python backend generates a processing file according to the data processing result, to enable a Unity frontend to read the processing file using a preset interface and perform display according to the processing file. That is, in the embodiments of the present disclosure, after the Python backend acquires the data processing instruction, the data processing instruction is processed firstly to obtain the data processing result, and then the processing file is generated according to the data processing result. In this way, the Unity frontend may read the processing file using the preset interface, which is beneficial for the Unity frontend to read the processing file of the Python backend and respond to the data processing instruction acquired by the Python backend in time, thereby achieving normal interaction between the Python backend and the Unity frontend and further achieving normal operation of the web page including the Python backend and the Unity frontend.

It is to be understood that the above general description and the following detailed description are merely illustrative and explanatory, and are not intended to limit the present disclosure.

### BRIEF DESCRIPTION OF THE DRAWINGS

The accompanying drawings, which are incorporated in and constitute a part of the specification, illustrate embodiments consistent with the present disclosure and, together with the description, serve to illustrate the technical solution of the disclosure.

FIG. 1 is a schematic interaction flowchart of a method for data processing provided by an embodiment of the present disclosure.

FIG. 2a is a schematic flowchart of an example of a method for data processing provided by an embodiment of the present disclosure.

FIG. 2b is a schematic flowchart of an example of another method for data processing provided by an embodiment of the present disclosure.

FIG. 3 is a schematic flowchart of a method for data processing provided by an embodiment of the present disclosure.

FIG. 4 is a schematic flowchart of another method for data processing provided by an embodiment of the present disclosure.

FIG. 5 is a schematic flowchart of another method for data processing provided by an embodiment of the present disclosure.

FIG. 6 is a schematic structural diagram of an apparatus for data processing provided by an embodiment of the present disclosure.

FIG. 7 is a schematic structural diagram of another apparatus for data processing provided by an embodiment of the present disclosure.

FIG. 8 is a schematic structural diagram of another apparatus for data processing provided by an embodiment of the present disclosure.

FIG. 9 is a schematic structural diagram of a web page processing device provided by an embodiment of the present disclosure.

FIG. 10 is a schematic structural diagram of another web page processing device provided by an embodiment of the present disclosure.

FIG. 11 is a schematic structural diagram of a server provided by an embodiment of the present disclosure.

FIG. 12 is a schematic structural diagram of a data processing system provided by an embodiment of the present disclosure.

### DETAILED DESCRIPTION

The technical solutions in the embodiments of the present disclosure will be clearly and completely described below in combination with the accompanying drawings in the embodiments of the present disclosure.

The embodiments of the present disclosure provide a method for data processing, which is applied to a data processing system. The data processing system may include interaction devices and a server, and the interaction devices may include a Unity frontend and a Python backend. The Unity frontend has powerful graphic functions and may be used for the design and display of an interaction interface of interaction device. The Unity frontend also has various output options and may support touch screen surfaces of any platform. The Python backend can perform data processing such as data mining, scientific calculation, image processing, artificial intelligence or the like, and may be used to perform data processing according to Python codes input by the interaction device and achieve the purpose of editing a page displayed on the Unity frontend.

The data processing system may be used for web page development, such as the web page game development. A web game is described below as an example. The Python backend establishes communication connections with the server and the Unity frontend, respectively, so that the Python backend may be used to read data from the server and the Unity frontend and also be used to send data to the server and the Unity frontend. The server is used to process a data processing request received by the Python backend, and the Unity frontend is used for the frontend display, such as display of an interface of a web game.

In order to enable the web game to operate normally, the embodiments of the present disclosure provide a method for data processing, which is applied to the data processing system mentioned above. FIG. 1 is a schematic interaction flow chart of a method for data processing provided by the embodiments of the present disclosure. As illustrated in FIG. 1, the method for data processing may include the following operations.

In S101, a Python backend 101 acquires a data processing instruction.

At present, the web game, as a way of leisure and entertainment, is widely pursued by the public. Generally, frontend display of the web game is made by using a language tool Unity to implement a frontend display interface of the web game, and a backend logic control of the web game is implemented by using a language tool Python to control the web game, that is, all programming logic can be completed through the Python backend, the Python backend operation is stripped from the Unity frontend game logic, and the Unity frontend may only play a display role. When the Unity frontend 102 and the Python backend 101 are used, it is necessary to use a plug-in IronPython to write a corresponding interface in the Unity frontend 102, to enable the Unity frontend 102 to parse and process a received data processing request.

However, due to the dynamic link characteristic of the plug-in IronPython, the plug-in IronPython may only be applied to an editing state of the Unity frontend 102, and the plug-in IronPython fails in the case that the game is released to the web page, which results in the web page game cannot operate normally.

In order to achieve normal operation of the web game, first, the Python backend 101 acquires the data processing instruction. In actual applications, after the web game is published, the developer may still use the Python backend 101 to operate the interface of the web game, so as to generate the data processing instruction. The data processing instruction may be a data processing instruction generated by click operation on a preset button, or may be a data processing instruction generated by a click operation on a specific area, or a corresponding data processing instruction automatically generated according to input codes. In addition, the data processing instruction may be an instruction for restarting or closing the web game, or may be a data processing instruction for selecting a character, selecting a skin and setting a character attribute in the web game. This is not limited in the embodiments of the present disclosure.

In order to obtain the data processing instruction, in some embodiments of the present disclosure, the operation in S101 may include that the Python backend 101 generates the data processing instruction according to received Python codes.

Generally, the developer or user may input the Python codes through an input device, for example, the user inputs the Python codes in a code input window of a browser, and the Python backend 101 may receive the Python codes, so that the Python backend 101 may generate the data processing instruction according to the Python codes. For example, the Python codes may be a Python operation expression, and the generated data processing instruction is an instruction carrying the Python operation expression.

In S102, the Python backend 101 sends the data processing instruction to the server 103.

After acquiring the data processing instruction, the Python backend 101 may package and send the data processing instruction to the server 103. For example, the data processing instruction is packaged and encrypted according to the Hypertext Transfer Protocol (Http protocol) to form a data packet and sent the data packet to the server 103. Communication between the Python backend 101 and the server 103 may be implemented using the File Transfer Protocol (FTP protocol), Simple Object Access Protocol (SOAP protocol), TELNET (remote login) protocol or the like.

In some embodiments of the present disclosure, the Python backend 101 may perform processing on its own according to the acquired data processing instruction to obtain a data processing result. This is not limited by the embodiments of the present disclosure.

In S103, the server 103 obtains the data processing result according to the data processing instruction.

In the implementation process, generally, in order to reduce the burden of the Python backend 101, the data processing instruction is sent to the server 103, to enable the server 103 to process the data processing instruction and obtain the data processing result. For example, the server 103 communicates with the Python backend 101 using the Http protocol, and after receiving the data packet sent by the Python backend 101, the server 103 parses and decrypts the data packet to obtain the data processing instruction. When the data processing instruction is an instruction including the Python operation expression, the Python processor of the server 103 calculates the Python operation expression to obtain the data processing result.

In order to obtain a more accurate data processing result, in some embodiments of the present disclosure, the operation in S103 may include the following actions. The server 103 receives a present page status file from the Python backend 101; and the server 103 obtains the data processing result according to the present page status file and the data processing instruction. The present page status file is transmitted by the Unity frontend 102 using a preset interface to the Python backend 101, and the preset interface is an interface written in a preset scripting language.

Generally, when the server 103 receives the present page status file from the Python backend 101, the present page status file is used to reflect interface information of the present page, including a modifiable attribute value, a modifiable target and the like. The present page status file is transmitted by the Unity frontend 102 using the preset interface to the Python backend 101, in such case, status information of the present page can be known. Then, the server 103 may obtain the data processing result according to the present page status file and the data processing instruction, so that the data processing result is not only obtained according to the data processing instruction, but also obtained combined with the status information of the present page, which causes the data processing result to be more accurate and effective.

In order to obtain a more accurate data processing result, in some embodiments of the present disclosure, the operation that the data processing result is obtained according to the present page status file and the data processing instruction may include the following actions. The server 103 determines whether processing of the present page status file according to the data processing instruction meets a preset condition. When the processing of the present page status file according to the data processing instruction meets the preset condition, a data processing result indicating result processing success is obtained according to the data processing instruction, to enable the Python backend 101 to generate a processing file indicating result processing success according to the data processing result, and enable the Unity frontend 102 to read the processing file indicating result processing success using the preset interface and preform a page refresh according to the processing file indicating result processing success. When the processing of the present page status file according to the data processing instruction does not meet the preset condition, a data processing result indicating result processing failure is obtained according to the data processing instruction, to enable the Python backend 101 to generate a processing file indicating result processing failure according to the data processing result, and enable the Unity frontend 102 to read the processing file indicating result processing failure using the preset interface and generate error information according to the processing file indicating result processing failure to indicate operation failure of the data processing instruction.

Generally, the server 103 processes the present page status file according to the data processing instruction firstly, and determines whether the processing of the present page status file according to the data processing instruction meets the preset condition, that is, the server 103 checks whether the data processing instruction is able to process the present page status file. When the data processing instruction is able to process the present page status file, the server 103 obtains the data processing result indicating result processing success. When the data processing instruction is unable to process the present page status file, the server 103 obtains the data processing result indicating result processing failure. For example, the data processing instruction needs to modify an attribute of a target person A in the interface, while there is no target person A in the present page status file or there is no attribute that needs to be modified, or the modified attribute value exceeds the allowable modification range, the server 103 determines that the data processing instruction is unable to process the present page status file and outputs the data processing result indicating result processing failure.

Then, for the data processing result indicating result processing success, the Python backend 101 may obtain the processing file indicating result processing success, and further the Unity frontend 102 may read the processing file indicating result processing success using the preset interface and display the processing file through the page refresh. For the data processing result indicating result processing failure, the Python backend 101 may obtain the processing file indicating result processing failure, and further the Unity frontend 102 may read the processing file indicating result processing failure and generate error information to indicate the operation failure of the data processing instruction. Result processing failure may be the case that the attribute value required to be modified does not meet a requirement or the modified target does not exist.

In S104, the server 103 returns the data processing result to the Python backend 101.

In a possible implementation, the server 103 returns the data processing result to the Python backend 101. For example, the data processing result is encrypted and packaged according to the Http protocol, and then sent to the Python backend 101, to enable the Python backend 101 to receive the data processing result.

In S105, the Python backend 101 generates a processing file according to the data processing result.

Herein, the server 103 returns the data processing result to the Python backend 101, and the Python backend 101 generates the processing file that may be successfully recognized by the Unity frontend 102. For example, the Python backend 101 acquires an Http data packet, decrypts and parses the data packet to obtain the data processing result, and then generates the processing file which may be read by the preset interface, such as a JavaScript Object Notation (j son) format file, by using a preset scripting language, such as Javascript. In this way, the Unity frontend 102 is enabled to read the processing file that can be recognized by its own using the preset interface, so that the processing file may be displayed on the web game, that is, the web game is enabled to be operated normally responsive to operations of the user.

In order to implement normal operation of the web game, in some embodiments of the present disclosure, the operation in S105 may include the following actions. The Python backend 101 parses the data processing result and generates a processing file recognizable by a preset scripting language, to enable the Unity frontend to read the processing file using the preset interface and perform page display according to the processing file.

In order to enable the processing file obtained by the Python backend 101 to be read by the Unity frontend 102, the Python backend 101 generates the processing file recognizable by the preset scripting language after parsing the data processing result, such that the Unity frontend 102 may read the processing file from the Python backend 101 through the preset interface and perform page display.

The preset interface is written in the preset scripting language, and the preset interface is a function for the Unity frontend 102 to interact with the external, which can implement functions of recognizing and reading the processing file generated by the Python backend 101. In this way, the Unity frontend 102 is enabled to read the processing file recognizable by the preset scripting language from the Python backend 101 through the preset interface, thereby facilitating normal operation of the web game.

In some embodiments of the present disclosure, the preset interface is written in a Javascript or Hyper Text Markup Language 5 (HTML5) scripting language. In this way, the following operations can be implemented only by defining a required intermediate protocol according to the actual application scenario: the Python backend 101 generates a processing file conforming to the intermediate protocol, and the Unity frontend 102 may recognize and read the processing file from the Python backend 101 through a preset interface conforming to the intermediate protocol. The intermediate protocol specifies rules for communication between the Python backend 101 and the Unity frontend 102, for example, specifies an external preset interface of the Unity frontend 102 and a format of the processing file generated by the Python backend 101.

The processing file mentioned above includes an identifier of result processing success or failure and an interface action sequence. That is, the content of the processing file includes not only the processing result but also the action sequence. The action sequence is an object that packages multiple actions, and when this object is executed, the packaged actions will be executed sequentially. The processing file may be an identifier of result processing success or an identifier of result processing failure, and may also include an interface action sequence of result processing success and an interface action sequence of result processing failure, to enable the Unity frontend 102 to determine, according to the processing result identifier, whether the present page needs to be updated according to the interface action sequence.

In S106, the Unity frontend 102 reads the processing file using the preset interface.

After the Python backend 101 obtains the processing file, the Unity frontend 102 may read the processing file using the preset interface. In the implementation process, the operation in S106 may include the following action. The Unity frontend 102 reads the processing file using the preset interface responsive to a received display instruction for the processing file; or the Unity frontend 102 reads the processing file using the preset interface according to a preset period.

Generally, the Unity frontend is a frontend display tool that may read status parameters or the like from the Javascript regularly or according to user instructions, update its own status and display the status changing process on a platform. The Unity frontend 102 may read the processing file using the preset interface immediately after receiving a display instruction for the processing file from the user, or the Unity frontend 102 may read the processing file using the preset interface according to the preset period, for example, every 1 s, which is not specifically limited in the embodiments of the present disclosure.

In S107, the Unity frontend 102 performs page display according to the processing file.

After reading the processing file, the Unity frontend 102 performs page display according to the processing file to feed back the processing result of the input Python codes to the user.

In order to implement page display of the processing file, in some embodiments of the present disclosure, the operation in S107 may include the following actions. The Unity frontend 102 performs page display on the processing file through a page refresh responsive to that a processing result of the processing file is result processing success.

When a processing result of the processing file is result processing success, the processing file may be displayed on the page through the page refresh for the user to view.

In order to implement page display of the processing file, in some embodiments of the present disclosure, the operation in S107 may include the following action. The Unity frontend 102 generates error information to indicate operation failure of the data processing instruction responsive to that the processing file includes the identifier of result processing failure.

When a processing result of the processing file is result processing failure, in such case, the error information may be generated and the error information is used to prompt the user that the processing result of the processing file is result processing failure, to enable the user to know the processing result for the data processing instruction. In other embodiments, the Unity frontend 102 may not update the present page directly and/or display information of update failure responsive to that the result of the processing file is the result processing failure.

It can be seen that, when the webpage game receives the data processing instruction, the obtained processing file may be a file indicating result processing success or result processing failure, and the Unity frontend 102 may perform different page displays according to the read processing file to feed back to the user.

In order to implement that the Unity frontend 102 transmits a present page status file to the Python backend 101 using the preset interface, the Unity frontend 102 is required to obtain the present page status file firstly. In order to obtain the present page status file, in some embodiments of the present disclosure, before the operation that the Unity frontend 102 transmits the present page status file to the Python backend 101 using the preset interface, the method may also include the following operation. The Unity frontend 102 generates the present page status file according to the present page status.

Generally, the Unity frontend 102 acquires the present page status firstly, and then generates the present page status file according to the present page status, so that the present page status file may be transmitted to the Python backend 101, to enable the Python backend 101 to transmit the present page status file to the server 103.

In addition, the Unity frontend 102 may also perform initialization. In some embodiments of the present disclosure, the method may also include the following operations. The Unity frontend 102 reads an initialization file using the preset interface; and the Unity frontend 102 performs page initialization according to the initialization file to obtain an initial page and display the initial page.

The preset interface is an interface for the Unity frontend 102 to interact with the external (such as the server 103 and the Python backend 101). For example, the preset interface may implement a transmission function of signaling and/or data information with the server 103 and the Python backend 101.

Generally, when the server 103 receives the user Python codes through the Python backend 101, the server 103 informs the Unity frontend 102 to performs initialization through the preset interface, and the Unity frontend 102 reads the initialization file using the same preset interface and then performs page initialization according to the initialization file to obtain the initial page and display the initial page. In this way, the Unity frontend 102 is enabled to perform page display on the processing file on the basis of the initialization page.

In the related art, the Unity technology is introduced as the frontend, in a web page development library is used and the plug-in IronPython is used in the Unity frontend. In the embodiments of the disclosure, the Python backend and the Unity frontend are developed independently without limiting the functionality, and communicate via the Javascript.

In the embodiments of the present disclosure, a frontend made by the Unity frontend platform is more interactive, a program dependence requirement for interaction between the Python backend and the Unity frontend is reduced, and various functional requirements can be adapted only by defining different intermediate protocols.

The method for data processing described in one or more embodiments described above are described below by way of example.

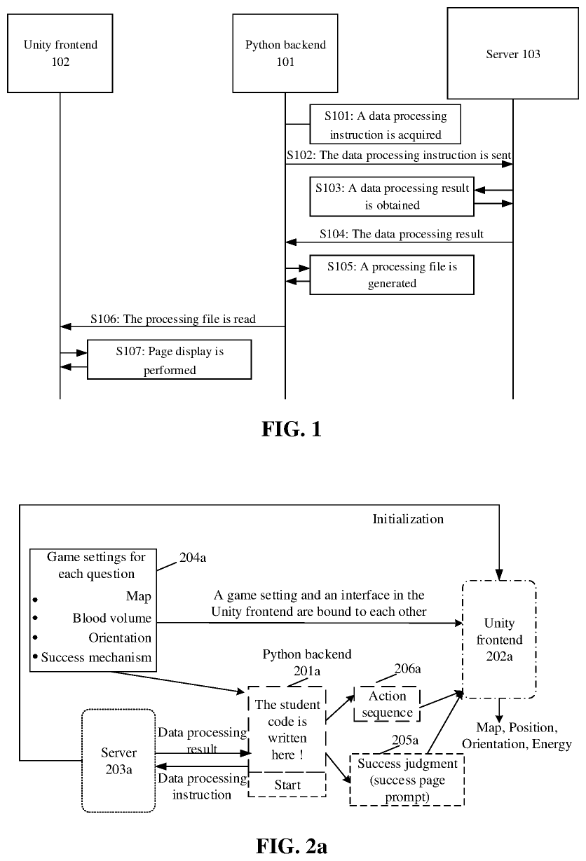

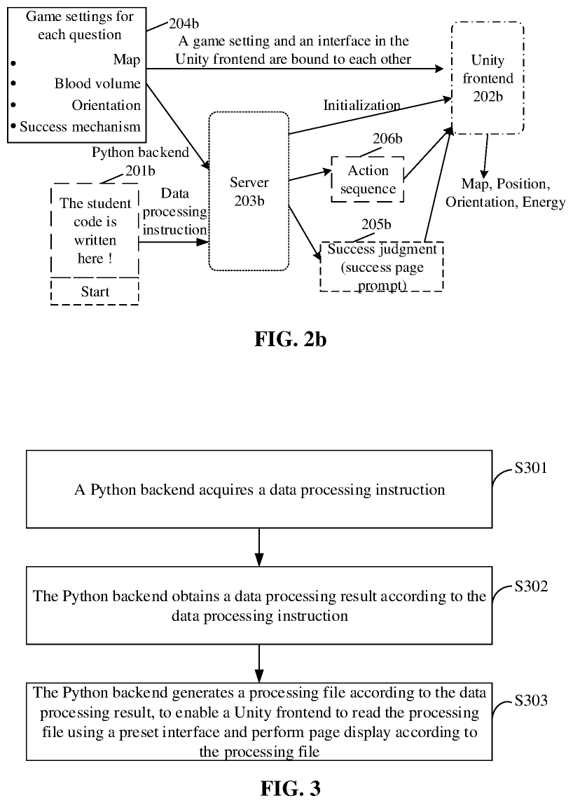

FIG. 2a is a schematic flowchart of an example of a method for data processing provided by the embodiments of the present disclosure. As illustrated in FIG. 2a, the following operations may be performed in a design process of a web game.

First, an external Javascript interface of a Unity frontend 202a is defined for manipulating the Unity frontend 202a outside the Unity development environment, and a game setting 204a in the web game and an interface in the Unity frontend 202a are bound to each other. The bound interface may be accessed through an interface written in Javascript. For example, in actual applications, the game setting 204a may include maps, blood volume, orientations, success mechanism and the like.

Then, a communication protocol between the Python backend 201a and the Unity frontend 202a through the Javascript is defined, and codes are written on the Python backend 201a, so that the Python backend 201a may implement data forwarding between the Unity frontend 202a and a server 203a through the Javascript. For example, after the Python backend 201a acquires a data processing instruction, the data processing instruction is sent to the server 203a through the Http protocol.

Next, the server 203a implements processing of the data processing instruction. For example, in actual applications, the server 203a may process the data processing instruction sent by the Python backend 201a to obtain the data processing result.

Finally, the Python backend 201a receives the data processing result and generates a processing file. For example, the data processing result may include result processing success and result processing failure. When a result of data processing is result processing success, the processing file may include a success judgment (success page prompt) 205a and an action sequence 206a. The processing file may be a file for a map, a position, an orientation and energy. The Unity frontend 202a reads the processing file using an interface written in the Javascript. For example, the Unity frontend 202a opens a “refresh” interface for the Javascript to access. The Javascript binds the interface to a game web page button, and the user clicks the game web page button to perform refresh on the game interface.

After the web page game is established based on FIG. 2a, the method for data processing may include the following operations. The server 203a receives a Python request read from the Python backend 201a, processes the Python request to obtain a Python result, and informs the Unity frontend 202a to perform initialization through the Javascript. The Python backend 201a reads the Python result through the Javascript and send the Python result to the Unity frontend 202a. The Unity frontend 202a executes the Python result.

Generally, when the user clicks a restart button of a game page, the Python backend receives a Python request for restarting the game. In such case, the Javascript can access the “restart” interface, trigger the Python backend 201a to invoke a reading instruction of the Javascript to read the Python request and invoke a sending instruction of the Javascript to send the Python request to a Python processor of the server 203a. The Python request may be a Python operation expression.

The Python processor processes the Python request to obtain a Python result, and the Python backend 201a reads the Python result from the server 203a and sends the Python result to the Unity frontend 202a. The Unity frontend 202a implements a restart of the web game.

FIG. 2b is a schematic flowchart of an example of a method for data processing provided by the embodiments of the present disclosure. As illustrated in FIG. 2b, the following operations may be performed in a design process of a web game.

First, an external Javascript interface of a Unity frontend 202b is defined for manipulating the Unity frontend 202b outside the Unity development environment, and a game setting 204b in the web game and an interface in the Unity frontend 202b are bound to each other. The bound interface may be accessed through an interface written in Javascript. For example, in actual applications, the game setting 204b may include maps, blood volume, orientations, success mechanism, and the like.

Then, a communication protocol between the Python backend 201b and the Unity frontend 202b through the Javascript is defined, and codes are written on the Python backend 201b, so that the Python backend 201b may implement data forwarding between the Unity frontend 202b and a server 203b through the Javascript. For example, after the Python backend 201b acquires a data processing instruction, the data processing instruction is sent to the server 203b through the Http protocol.

Next, the server 203b implements processing of the data processing instruction. For example, in actual applications, the server 203b may process the data processing instruction sent by the Python backend 201b to obtain a data processing result, and generate a processing file according to the data processing result. For example, the data processing result may include result processing success and result processing failure. When a result of data processing is result processing success, the processing file may include a success judgment (success page prompt) 205b and an action sequence 206b. The processing file may be a file for a map, a position, an orientation and energy. The Unity frontend 202b reads the processing file using an interface written in the Javascript. For example, the Unity frontend 202b opens a “refresh” interface for the Javascript to access. The Javascript binds the interface to a certain game web page button, and the user clicks the game web page button to perform a game interface refresh.

Finally, the Unity frontend reads the processing file using a Javascript interface and performs page display according to the processing file.

After the web game is established based on FIG. 2b, the method for data processing may include the following operations.

The server 203b receives a Python request read by the Python backend 201b, processes the Python request to obtain a Python result, and informs the Unity frontend 202b to perform initialization through the Javascript. The server 203b sends the Python result to the Unity frontend 202b, and the Unity frontend 202b executes the Python result.

In the method for data processing provided in the embodiments of the present disclosure, referring to FIG. 2b, the following operations may also be performed in the design process of the web game.

In 301, all logic in the backend is developed in Python language.

In 302, a protocol for communication of the Python backend with the Javascript is defined. For example, the backend runs and outputs a j son file with a specific format, the Javascript reads the file when the user clicks a button, and interacts with the Unity frontend.

In 303, an external Javascript interface of the Unity frontend is defined for manipulating the frontend outside the Unity development environment.

The protocol in 302 may be exemplified as the following operations, which is a protocol architecture constructed by a student encoding product using the embodiments of the present disclosure.

In 3021, the server receives an input operation from a user.

In 3022, the server informs the Unity frontend to perform initialization through the JS and runs the Python backend according to the input.

In 3023, after the server terminates running of the Python backend, the Python backend outputs a running result that can be read by the JS, and the JS instruction informs the Unity frontend to perform a specific operation with the running result as input.

The user can establish a system of the Python backend and the Unity frontend by using the present architecture. By defining different protocols, an interaction between the Python backend and the Unity frontend may be changed according to requirements.

The embodiments of the present disclosure may also be applied to the field of educational robots.

According to a method for data processing provided by the embodiments of the present disclosure, the method is applied to a web page processing device and the processing device includes a Python backend. The method may include the following operations. The Python backend acquires a data processing instruction. The Python backend obtains a data processing result according to the data processing instruction; and the Python backend generates a processing file according to the data processing result, to enable a Unity frontend to read the processing file using a preset interface and perform page display according to the processing file. The procedure of implementing the abovementioned method may be referred to the contents of the abovementioned embodiments, which will not be repeated in the present disclosure.

In the embodiments of the present disclosure, the Python backend obtains the data processing result according to the acquired data processing instruction, and parses the data processing result to generate the processing file. In this way, the Unity frontend may read the processing file using the preset interface and perform page display. In such case, it is beneficial for the Unity frontend to process the data processing request in the web game, and enable to respond to the data processing instruction in time, thereby achieving normal operation of the web game.

The method for data processing will be described with respect to each device side deployed to the data processing system.

First, a method for data processing is described in terms of a Python backend side.

The embodiments of the present disclosure provide a method for data processing. FIG. 3 is a schematic flowchart of the method for data processing provided by the embodiments of the present disclosure. As illustrated in FIG. 3, the method for data processing may include the following operations.

In S301, a Python backend acquires a data processing instruction.

In S302, the Python backend obtains a data processing result according to the data processing instruction.

In S303, the Python backend generates a processing file according to the data processing result, to enable a Unity frontend to read the processing file using a preset interface and perform page display according to the processing file.

In some embodiments of the present disclosure, the operation in S302 may include the following actions. The Python backend sends the data processing instruction to a server, to enable the server to obtain the data processing result according to the data processing instruction and return the data processing result, and receives the data processing result returned by the server.

In some embodiments of the present disclosure, the operation in S303 may include the following actions. The Python backend generates, according to the data processing result, a processing file recognizable by a preset scripting language, to enable the Unity frontend to read the processing file using the preset interface and perform page display according to the processing file. The preset interface is written in the preset scripting language.

The preset interface is written in a Javascript or HTML5 scripting language, and the processing file includes an identifier of result processing success or failure and an interface action sequence.

In some embodiments of the present disclosure, the operation in S301 may include: the Python backend generates the data processing instruction according to received Python codes.

Next, a method for data processing is described in terms of a Unity frontend side.

The embodiments of the present disclosure provide a method for data processing. FIG. 4 is a schematic flowchart of another method for data processing according to the embodiments of the present disclosure. As illustrated in FIG. 4, the method for data processing may include the following operations.

In S401, a Unity frontend reads a processing file using a preset interface.

The processing file is a result file generated by a Python backend according to a data processing result, and the data processing result is obtained by the Python backend according to an acquired data processing instruction.

In S402, the Unity frontend performs page display according to the processing file.

In some embodiments of the present disclosure, the operation in S402 may include that the Unity frontend performs a page refresh according to an interface action sequence in the processing file responsive to that the processing file includes an identifier of result processing success.

In some embodiments of the present disclosure, the operation in S402 may include that the Unity frontend generates error information to indicate operation failure of the data processing instruction responsive to that the processing file includes an identifier of result processing failure.

In some embodiments of the present disclosure, the method may also include the following operations. The Unity frontend transmits a present page status file to the Python backend using the preset interface, to enable the Python backend to send the present page status file to a server and enable the server to obtain the data processing result according to the present page status file and the data processing instruction.

In some embodiments of the present disclosure, before the operation that the Unity frontend transmits the present page status file to the Python backend using the preset interface, the method may also include the following operation. The Unity frontend generates the present page status file according to the present page status.

In some embodiments of the present disclosure, the method may also include the following operations. The Unity frontend reads an initialization file using the preset interface; and the Unity frontend performs page initialization according to the initialization file to obtain an initial page and display the initial page.

In some embodiments of the present disclosure, the operation in S401 may include the following actions. The Unity frontend reads the processing file using the preset interface responsive to a received display instruction for the processing file; or the Unity frontend reads the processing file using the preset interface according to a preset period. The preset interface is written in a Javascript or HTML5 scripting language.

Again, a method for data processing is described in terms of a server side.

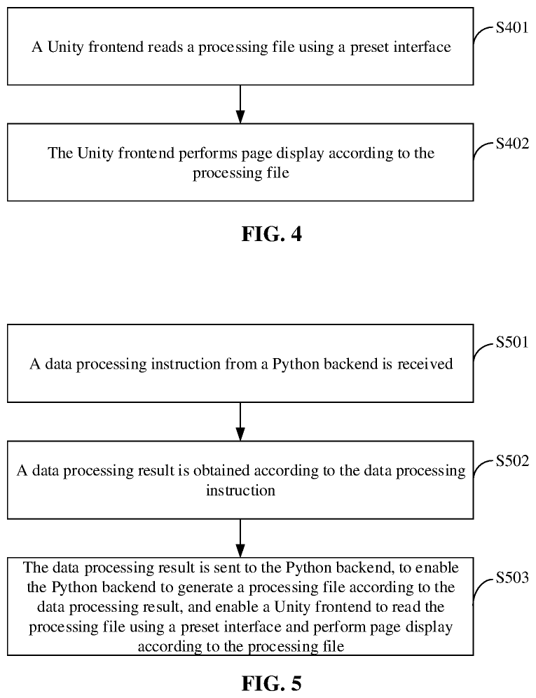

The embodiments of the present disclosure provide a method for data processing, which is applied to a server. FIG. 5 is a schematic flowchart of another method for data processing provided by the embodiments of the present disclosure. As illustrated in FIG. 5, the method for data processing may include the following operations. In S501, a data processing instruction from a Python backend is received. In S502, a data processing result is obtained according to the data processing instruction. In S503, the data processing result is sent to the Python backend, to enable the Python backend to generate a processing file according to the data processing result, and enable a Unity frontend to read the processing file using a preset interface and perform page display according to the processing file.

In some embodiments of the present disclosure, the operation in S502 may include the following actions. A present page status file from the Python backend is received, and the data processing result is obtained according to the present page status file and the data processing instruction. The present page status file is transmitted by the Unity frontend using the preset interface to the Python backend.

In some embodiments of the present disclosure, the operation that the data processing result is obtained according to the present page status file and the data processing instruction includes the following actions. It is determined whether processing of the present page status file according to the data processing instruction meets a preset condition. Responsive to that the processing of the present page status file according to the data processing instruction meets the preset condition, a data processing result indicating result processing success is obtained according to the data processing instruction, to enable the Python backend to generate a processing file indicating result processing success according to the data processing result, and enable the Unity frontend to read the processing file indicating result processing success using the preset interface and preform a page refresh according to the processing file indicating result processing success.

In some embodiments of the present disclosure, after the operation that it is determined whether processing of the present page status file according to the data processing instruction meets a preset condition, the method also include the following operations. Responsive to that the processing of the present page status file according to the data processing instruction does not meet the preset condition, a data processing result indicating result processing failure is obtained according to the data processing instruction, to enable the Python backend to generate a processing file indicating result processing failure according to the data processing result, and enable the Unity frontend to read the processing file indicating result processing failure using the preset interface and generate error information according to the processing file indicating result processing failure to indicate operation failure of the data processing instruction.

The processing file includes an identifier of result processing success or failure and an interface action sequence. The preset interface is written in a Javascript or HTML5 scripting language.

It is to be understood by those skilled in the art that, in the above methods of the specific implementations, the order in which the operations are written does not imply a strict order of execution to constitute any limitation on the implementation process, and the order in which the operations are executed should be determined in terms of their function and possible intrinsic logic.

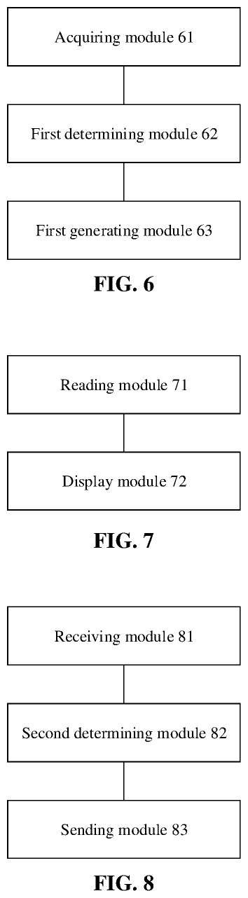

The embodiments of the present disclosure provide an apparatus for data processing, which is configured to implement functions of the Python backend. FIG. 6 is a schematic structural diagram of an apparatus for data processing provided by the embodiments of the present disclosure. As illustrated in FIG. 6, the apparatus may include an acquiring module 61, a first determining module 62 and a first generating module 63.

The acquiring module 61 is configured to acquire a data processing instruction.

The first determining module 62 is configured to obtain a data processing result according to the data processing instruction.

The first generating module 63 is configured to generate a processing file according to the data processing result, to enable a Unity frontend to read the processing file using a preset interface and perform page display according to the processing file.

In some embodiments of the present disclosure, the first determining module 62 is configured to send the data processing instruction to a server, to enable the server to obtain the data processing result according to the data processing instruction and return the data processing result, and receive the data processing result returned by the server.

In some embodiments of the present disclosure, the first generating module 63 is configured to generate, according to the data processing result, a processing file recognizable by a preset scripting language, to enable the Unity frontend to read the processing file using the preset interface and perform page display according to the processing file. The preset interface is written in the preset scripting language.

The preset interface is written in a Javascript or HTML5 scripting language. The processing file includes an identifier of result processing success or failure and an interface action sequence.

In some embodiments of the present disclosure, the acquiring module 61 is configured to generate the data processing instruction according to received Python codes.

In actual applications, the acquiring module 61, the first determining module 62 and the first generating module 63 may be implemented by a processor located on the Python backend, typically be implemented by a Central Processing Unit (CPU), a Microprocessor Unit (MPU), a Digital Signal Processing (DSP), a Field Programmable Gate Array (FPGA), or the like.

The embodiments of the present disclosure provide an apparatus for data processing, which is configured to implement functions of the Unity frontend. FIG. 7 is a schematic structural diagram of another apparatus for data processing provided by the embodiments of the present disclosure. As illustrated in FIG. 7, the apparatus for data processing may include a reading module 71 and a display module 72.

The reading module 71 is configured to read a processing file using a preset interface. The processing file is a result file generated by a Python backend according to a data processing result, and the data processing result is obtained by the Python backend according to an acquired data processing instruction.

The display module 72 is configured to perform page display according to the processing file.

In some embodiments of the present disclosure, the display module 72 is configured to perform a page refresh according to an interface action sequence in the processing file responsive to that the processing file includes an identifier of result processing success.

In some embodiments of the present disclosure, the display module 72 is configured to generate error information to indicate operation failure of the data processing instruction responsive to that the processing file includes an identifier of result processing failure.

In some embodiments of the present disclosure, the apparatus also includes a transmission module. The transmission module is configured to transmit a present page status file to the Python backend using the preset interface, to enable the Python backend to send the present page status file to a server and enable the server to obtain the data processing result according to the present page status file and the data processing instruction.

In some embodiments of the present disclosure, the apparatus also includes a second generating module. The second generating module is configured to, before the present page status file is transmitted to the Python backend using the preset interface, generate the present page status file according to the present page status.

In some embodiments of the present disclosure, the apparatus also includes an initialization module. The initialization module is configured to read an initialization file using the preset interface, and perform page initialization according to the initialization file to obtain an initial page and display the initial page.

In some embodiments of the present disclosure, the reading module is configured to read the processing file using the preset interface responsive to a received display instruction for the processing file; or read the processing file using the preset interface according to a preset period.

The preset interface is written in a Javascript or HTML5 scripting language.

In actual applications, the reading module 71, the display module 72, the transmission module, the second generating module and the initialization module may be implemented by a processor located on the Unity frontend, typically be implemented by a CPU, an MPU, a DSP, a FPGA or the like.

The embodiments of the present disclosure provide an apparatus for data processing, which is configured to implement functions of the sever. FIG. 8 is a schematic structural diagram of another apparatus for data processing provided by the embodiments of the present disclosure. As illustrated in FIG. 8, the apparatus for data processing may include a receiving module 81, a second determining module 82 and a sending module 83.

The receiving module 81 is configured to receive a data processing instruction from a Python backend.

The second determining module 82 is configured to obtain a data processing result according to the data processing instruction.

The transmitting module 83 is configured to send the data processing result to the Python backend, to enable the Python backend to generate a processing file according to the data processing result, and enable a Unity frontend to read the processing file using a preset interface and perform page display according to the processing file.

In some embodiments of the present disclosure, the second determination module 82 includes a receiving submodule and a determining submodule.

The receiving submodule is configured to receive a present page status file from the Python backend.

The determination submodule is configured to obtain the data processing result according to the present page status file and the data processing instruction.

The present page status file is transmitted by the Unity frontend using the preset interface to the Python backend.

In some embodiments of the present disclosure, the determining submodule is configured to determine whether processing of the present page status file according to the data processing instruction meets a preset condition, responsive to that the processing of the present page status file according to the data processing instruction meets the preset condition, obtain a data processing result indicating result processing success according to the data processing instruction, to enable the Python backend to generate a processing file indicating result processing success according to the data processing result, and enable the Unity frontend to read the processing file indicating result processing success using the preset interface and preform a page refresh according to the processing file indicating result processing success.

In some embodiments of the present disclosure, the determining submodule is also configured to, after it is determined whether the processing of the present page status file according to the data processing instruction meets the preset condition, responsive to that the processing of the present page status file according to the data processing instruction does not meet the preset condition, obtain a data processing result indicating result processing failure according to the data processing instruction, to enable the Python backend to generate a processing file indicating result processing failure according to the data processing result, and enable the Unity frontend to read the processing file indicating result processing failure using the preset interface and generate error information according to the processing file indicating result processing failure to indicate operation failure of the data processing instruction.

The processing file includes an identifier of result processing success or failure and an interface action sequence. The preset interface is written in a Javascript or HTML5 scripting language.

In actual applications, the receiving module 81, the second determining module 82, the sending module 83, the receiving submodule and the determining submodule may be implemented by a processor located on the server, typically be implemented by a CPU, an MPU, a DSP, a FPGA or the like.

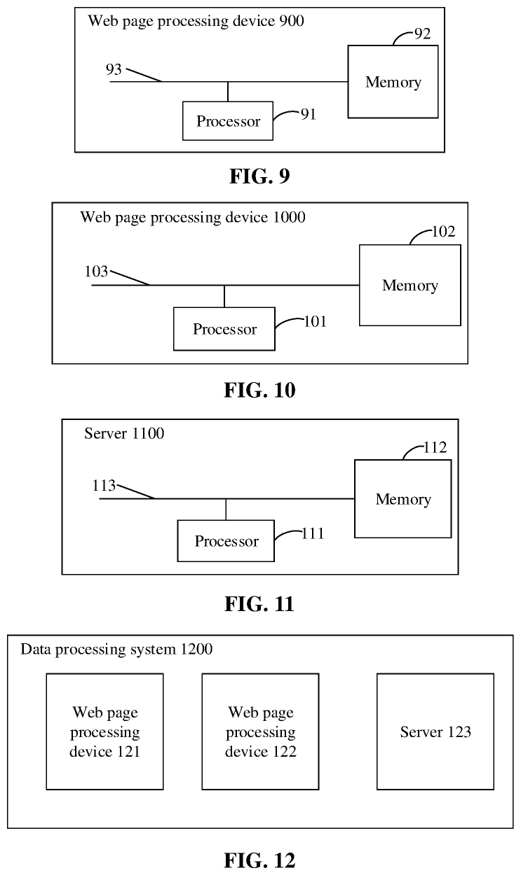

FIG. 9 is a schematic structural diagram of a web page processing device provided by the embodiments of the present disclosure. As illustrated in FIG. 9, the embodiments of the present disclosure provide a web page processing device 900, which includes a processor 91, a memory 92 and a communication bus 93.

The communication bus 93 is configured to implement connection communication between the processor 91 and the memory 92.

The processor 91 is configured to execute a data processing program stored in the memory 92 to implement the method for data processing described in the one or more embodiments executed by the Python backend side.

It should be noted that, in actual applications, various components in the web page processing device 900 are coupled together via the communication bus 93. It is to be understood that the communication bus 93 is configured to implement connection communication between these components. The communication bus 93 includes, in addition to a data bus, a power bus, a control bus, and a status signal bus. For clarity of illustration, however, various buses are labeled as the communication bus 93 in FIG. 9.

FIG. 10 is a schematic structural diagram of another web page processing device provided by the embodiments of the present disclosure. As illustrated in FIG. 10, the embodiments of the present disclosure provide a web page processing device 1000. The web page processing device 1000 includes a processor 101, a memory 102 and a communication bus 103.

The communication bus 103 is configured to implement connection communication between the processor 101 and the memory 102.

The processor 101 is configured to execute a data processing program stored in the memory 102 to implement the method for data processing described in the above one or more embodiments executed by the Unity frontend.

It should be noted that, in actual applications, various components in the web page processing device 1000 are coupled together via the communication bus 103. It is to be understood that the communication bus 103 is configured to implement connection communication between these components. The communication bus 103 includes, in addition to a data bus, a power bus, a control bus, and a status signal bus. For clarity of illustration, however, various buses are labeled as the communication bus 103 in FIG. 10.

The embodiments of the present disclosure also provides a web page processing device, the structure of which may refer to FIG. 9 or FIG. 10, and a processor thereof may be configured to simultaneously implement the method for data processing described in one or more embodiments executed by the Python backend side and the Unity frontend side.

FIG. 11 is a schematic structural diagram of a server provided by the embodiments of the present disclosure. As illustrated in FIG. 11, the embodiments of the present disclosure provide a server 1100, which includes a processor 111, a memory 112 and a communication bus 113.

The communication bus 113 is configured to implement connection communication between the processor 111 and the memory 112.

The processor 111 is configured to execute a data processing program stored in the memory 112 to implement the method for data processing described in the above one or more embodiments executed on the server side.

It should be noted that, in actual applications, various components in the server 1100 are coupled together via the communication bus 113. It is to be understood that the communication bus 113 is configured to implement connection communication between these components. The communication bus 113 includes, in addition to a data bus, a power bus, a control bus, and a status signal bus. For clarity of illustration, however, various buses are labeled as the communication bus 113 in FIG. 11.

FIG. 12 is a schematic structural diagram of a data processing system provided by the embodiments of the present disclosure. As illustrated in FIG. 12, the embodiments of the present disclosure provide a data processing system 1200. The data processing system 1200 includes a web page processing device 121, a web page processing device 122 and a server 123.

The data processing system 1200 includes the web page processing device 121 for implementing the method for data processing executed by the Python backend in the one or more embodiments, the web page processing device 122 for implementing the method for data processing executed by the Unity frontend in the one or more embodiments, and the server 123 for implementing the method for data processing executed by the sever in the one or more embodiments. The web page processing device 121 may be the Python backend described in the one or more embodiments, the web page processing device 122 may be the Unity frontend described in the one or more embodiments, and the server 123 may be the server described in the one or more embodiments.

The embodiments of the present disclosure also provide a computer readable storage medium having stored one or more programs executable by one or more processors to implement the method for data processing described in the one or more embodiments executed by the Python backend, or the method for data processing described in the one or more embodiments executed by the Unity frontend and the method for data processing described in the one or more embodiments executed by the server. The computer readable storage medium may be a volatile memory, such as a Random-Access Memory (RAM); Or a non-volatile memory, such as a Read-Only Memory (ROM), a flash memory, a Hard Disk Drive (HDD) or a Solid-State Drive (SSD); and it may also be a device including one or any combination of the above memories, such as a mobile phone, a computer, a tablet device, a personal digital assistant, etc.

Accordingly, the embodiments of the present disclosure also provide a computer program including computer readable codes. When the computer readable codes are run in an electronic device, a processor in the electronic device executes any of the methods for data processing provided in the embodiments of the present disclosure.

The foregoing description of the various embodiments is intended to emphasize differences between the various embodiments, the same or similar may be cross-referenced and details are not described herein for the purpose of brevity.

The term “and/or” in the present disclosure is merely an association relationship describing associated objects and represents that three relationships may exist. For example, A and/or B may represent three conditions: i.e., independent existence of A, existence of both A and B and independent existence of B.

Those skilled in the art will understand that the embodiments of the present disclosure may be provided as a method, a system or a computer program product. Thus, the present disclosure may take the form of hardware embodiments, software embodiments or embodiments combining software and hardware aspects. Moreover, the present disclosure may take the form of a computer program product implemented on one or more computer usable storage media (including, but not limited to, a magnetic disk memory, optical memory, etc.) having computer usable program codes therein.

The present disclosure is described with reference to flowcharts and/or block diagrams of methods, devices (systems) and computer program products according to the embodiments of the present disclosure. It is to be understood that each flow and/or block in the flowcharts and/or block diagrams, as well as combinations of flows and/or blocks in the flowcharts and/or block diagrams, may be implemented by computer program instructions. These computer program instructions may be provided to a processor of a general computer, dedicated computer, embedded processor or other programmable signal processing device to produce a machine, so that the instructions executed by the processor of the computer or other programmable signal processing devices generate a device for implementing the functions specified in one flow or multiple flows of the flowchart and/or one block or multiple blocks of block diagrams.

These computer program instructions may also be stored in a computer readable memory capable of directing the computer or other programmable signal processing devices to operate in a specific manner, such that the instructions stored in the computer readable memory produce an article of manufacture including an instruction device, and the instruction device realizes the functions specified in one flow or multiple flows of the flowchart and/or one block or multiple blocks of block diagrams.

These computer program instructions may also be loaded on the computer or other programmable signal processing devices, such that a series of operation steps are executed on the computer or other programmable devices to produce a computer-implemented process, such that the instructions executed on the computer or other programmable devices provide steps for implementing the functions specified in one flow or multiple flows of the flowchart and/or one block or multiple blocks of block diagrams.

The foregoing is the preferred embodiments of the present disclosure and not intended to limit the scope of protection of the present disclosure.

1. A method for data processing, comprising:
acquiring, by a Python backend, a data processing instruction;
obtaining, by the Python backend, a data processing result according to the data processing instruction; and
generating, by the Python backend, a processing file according to the data processing result, to enable a Unity frontend to read the processing file using a preset interface and perform page display according to the processing file.

2. The method of claim 1, wherein obtaining, by the Python backend, the data processing result according to the data processing instruction comprises:
sending, by the Python backend, the data processing instruction to a server, to enable the server to obtain the data processing result according to the data processing instruction and return the data processing result; and
receiving the data processing result returned by the server.

3. The method of claim 1, wherein generating, by the Python backend, the processing file according to the data processing result, to enable the Unity frontend to read the processing file using the preset interface and perform page display according to the processing file comprises:
generating, by the Python backend according to the data processing result, the processing file recognizable by a preset scripting language, to enable the Unity frontend to read the processing file using the preset interface and perform page display according to the processing file;
wherein the preset interface is written in the preset scripting language.

4. The method of claim 1, wherein the processing file comprises an identifier of result processing success or failure and an interface action sequence.

5. The method of claim 1, wherein acquiring, by the Python backend, the data processing instruction comprises:
generating, by the Python backend, the data processing instruction according to received Python codes.

6. A method for data processing, comprising:
reading, by a Unity frontend, a processing file using a preset interface, wherein the processing file is a result file generated by a Python backend according to a data processing result, and the data processing result is obtained by the Python backend according to an acquired data processing instruction; and
performing, by the Unity frontend, page display according to the processing file.

7. The method of claim 6, wherein performing, by the Unity frontend, page display according to the processing file comprises:
performing, by the Unity frontend, a page refresh according to an interface action sequence in the processing file responsive to that the processing file comprises an identifier of result processing success.

8. The method of claim 6, wherein performing, by the Unity frontend, page display according to the processing file comprises:
generating, by the Unity frontend, error information to indicate operation failure of the data processing instruction responsive to that the processing file comprises an identifier of result processing failure.

9. The method of claim 6, further comprising:
transmitting, by the Unity frontend, a present page status file to the Python backend using the preset interface, to enable the Python backend to send the present page status file to a server and enable the server to obtain the data processing result according to the present page status file and the data processing instruction.

10. The method of claim 9, wherein before transmitting, by the Unity frontend, the present page status file to the Python backend using the preset interface, the method further comprises:
generating, by the Unity frontend, the present page status file according to present page status.

11. The method of claim 6, further comprising:
reading, by the Unity frontend, an initialization file using the preset interface; and
performing, by the Unity frontend, page initialization according to the initialization file to obtain an initial page and display the initial page.

12. The method of claim 6, wherein reading, by the Unity frontend, the processing file using the preset interface comprises:
reading, by the Unity frontend, the processing file using the preset interface responsive to a received display instruction for the processing file; or
reading, by the Unity frontend according to a preset period, the processing file using the preset interface.

13. A method for data processing, applied to a server, the method comprising:
receiving a data processing instruction from a Python backend;
obtaining a data processing result according to the data processing instruction; and
sending the data processing result to the Python backend, to enable the Python backend to generate a processing file according to the data processing result, and enable a Unity frontend to read the processing file using a preset interface and perform page display according to the processing file.

14. The method of claim 13, wherein obtaining the data processing result according to the data processing instruction comprises:
receiving a present page status file from the Python backend; and
obtaining the data processing result according to the present page status file and the data processing instruction,
wherein the present page status file is transmitted to the Python backend by the Unity frontend using the preset interface.

15. The method of claim 14, wherein obtaining the data processing result according to the present page status file and the data processing instruction comprises:
determining whether processing of the present page status file according to the data processing instruction meets a preset condition; and
responsive to that the processing of the present page status file according to the data processing instruction meets the preset condition, obtaining, according to the data processing instruction, a data processing result indicating result processing success, to enable the Python backend to generate a processing file indicating result processing success according to the data processing result, and enable the Unity frontend to read the processing file indicating result processing success using the preset interface and preform a page refresh according to the processing file indicating result processing success.

16. The method of claim 15, wherein after determining whether the processing of the present page status file according to the data processing instruction meets the preset condition, the method further comprises:
responsive to that the processing of the present page status file according to the data processing instruction does not meet the preset condition, obtaining, according to the data processing instruction, a data processing result indicating result processing failure, to enable the Python backend to generate a processing file indicating result processing failure according to the data processing result, and enable the Unity frontend to read the processing file indicating result processing failure using the preset interface and generate error information according to the processing file indicating result processing failure to indicate operation failure of the data processing instruction.

17. The method of claim 13, wherein the processing file comprises an identifier of result processing success or failure and an interface action sequence.

18. A web page processing device, comprising a processor, a memory and a communication bus; wherein,
the communication bus is configured to implement connection communication between the processor and the memory;
the processor is configured to execute a data processing program stored in the memory to implement the method for data processing of claim 1.

19. A web page processing device, comprising a processor, a memory and a communication bus; wherein,
the communication bus is configured to implement connection communication between the processor and the memory;
the processor is configured to execute a data processing program stored in the memory to implement the method for data processing of claim 6.

20. A server, comprising a processor, a memory and a communication bus; wherein,
the communication bus is configured to implement connection communication between the processor and the memory;
the processor is configured to execute a data processing program stored in the memory to implement the method for data processing of claim 13.
